(19) United States
(12) Patent Application Publication
(10) Pub. No.: US 2004/0096344 A1
(43) Pub. Date: May 20, 2004

(54) Simplified piston slidable in a cylinder

(75) Inventor: Stefano Meucci, Florence (IT)

Correspondence Address: NIXON & VANDERHYE, PC, 1100 N GLEBE ROAD, 8TH FLOOR, ARLINGTON, VA, 22201-4714, US

(73) Assignee: NUOVO PIGNONE HOLDING S.p.A., Florence (IT)

(21) Appl. No.: 10/704,664

(22) Filed: Nov. 12, 2003

(30) Foreign Application Priority Data
Nov. 13, 2002 (IT) MI2002A 002400

(51) Int. Cl. F04B 35/04; F16J 1/00

(52) U.S. Cl. 417/410.1; 92/172

(57) ABSTRACT

A simplified piston (14), slidable in a cylinder (16), moved by magnetic coupling to an external magnetic element (20) which moves along the cylinder (16).

The present invention relates to a simplified piston slidable in a cylinder.

In the prior art, there are numerous known types of pistons for cylinders, for example those used in machines of the reciprocating type such as reciprocating compressors.

Such a piston, which slides in an essentially guided way in a cylinder, typically comprises a piston body fitted on at least one rod which is generally central.

The cylinder is generally closed at its two bases, but has an aperture for the shaft which emerges from the cylinder in such a way that motion can be transmitted to the piston body; for example, in the case of a reciprocating compressor, the rod is moved by a reciprocating motor.

A mechanical seal must be provided around this aperture to prevent leakage of the fluid contained in the cylinder or, conversely, the entry of dirt into the cylinder from the exterior.

The mechanical seal is an element which must be correctly managed and kept in good condition, especially in the case of operations with fluids which are environmentally polluting and harmful to persons.

The object of the present invention is therefore to overcome the aforementioned problems and in particular that of providing a simplified piston slidable in a cylinder but which has no operating rod and therefore no corresponding mechanical seals.

Another object of the present invention is to provide a simplified piston slidable in a cylinder and which is particularly reliable, functional and relatively inexpensive.

These and other objects of the present invention are achieved with a simplified piston slidable in a cylinder as described in claim 1.

Further characteristics of a simplified piston slidable in a cylinder are described in the subsequent claims.

The characteristics and advantages of a simplified piston slidable in a cylinder according to the present invention will be made clearer by the following description, provided by way of example and without restrictive intent, with reference to the attached schematic drawing in which:

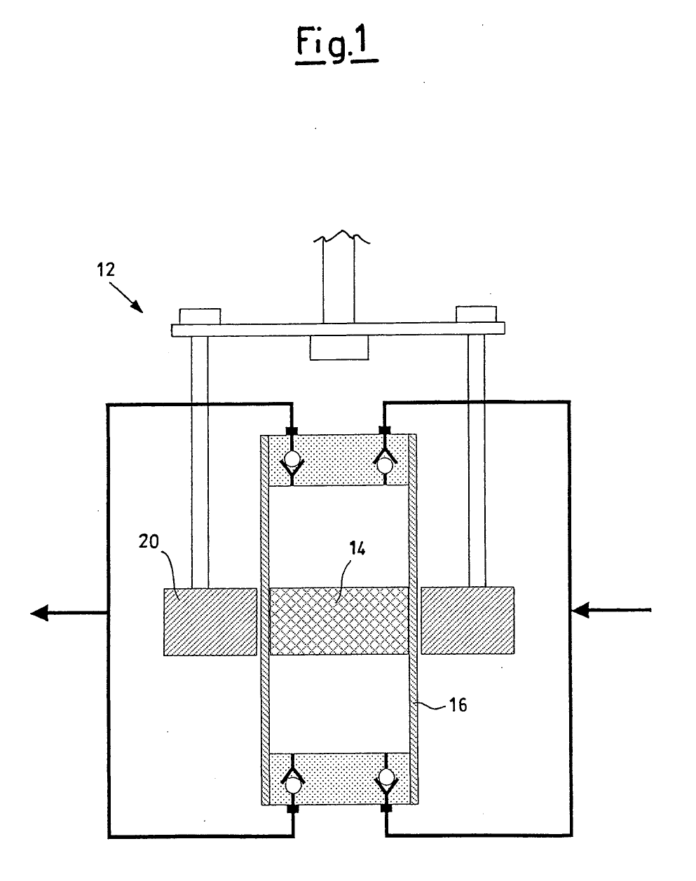

FIG. 1 is a lateral and cross-sectional view of a reciprocating compressor which includes a simplified piston slidable in a cylinder according to the present invention.

With reference to FIG. 1, this shows a reciprocating compressor, indicated as a whole by 12, which includes a simplified piston 14 slidable in a cylinder 16 according to the present invention.

In the illustrated example, according to the present invention, the reciprocating compressor 12 is double-acting, and the piston 14 has no central operating rod.

The piston 14 is made from metallic material and is slidable in a cylinder 16 which is made from a nonmagnetic material.

An external magnetic element 20, such as a ring, slidable externally along the cylinder 16, is also provided. The magnetic element 20 is moved, for example, by a reciprocating motor of the pneumatic type, which is not shown in the figure.

The operation of the simplified piston 14 slidable in a cylinder 16 according to the invention is clear from what has been described above with reference to the figure, and is briefly as follows.

The motion is transmitted to the piston 14 by magnetic coupling from the exterior of the cylinder 16 of nonmagnetic material, by means of the magnetic element 20.

The magnetic element 20 is moved along and outside the cylinder 16.

The magnetic field of the magnetic element 20 moves the piston 14, which is generally made from metallic material or other material sensitive to the magnetic field.

The absence of any seal in contact with the exterior makes the reciprocating compressor constructed with the piston 14 according to the invention, without a rod, particularly suitable for applications where dangerous gases and high pressures are used.

The very high reliability of the piston 14 according to the invention makes it suitable for numerous applications with all types of gas or liquid.

The characteristics of the simplified piston slidable in a cylinder according to the present invention, and the advantages thereof, will be clearly understood from the above description.

The following concluding remarks and observations will be made in order to define the aforesaid advantages more precisely and clearly.

In the first place, it should be noted that the simplified piston slidable in a cylinder according to the invention can be conveniently used in applications in which a polluting or harmful process fluid is used.

It is also pointed out that the simplified piston slidable in a cylinder according to the invention is simple and reliable in use and is inexpensive by comparison with the prior art.

Finally, it is clear that the simplified piston slidable in a cylinder designed in this way can be modified and varied in numerous ways, all within the scope of the invention; furthermore, all the components can be replaced by technically equivalent elements. In practice, the materials used and the forms and dimensions can be chosen at will, subject to technical requirements.

1. Simplified piston (14) slidable in a cylinder (16), characterized in that it is moved by magnetic coupling to an external magnetic element (20) which moves along the said cylinder (16).

2. Piston (14) according to claim 1, characterized in that the said external magnetic element (20) is a ring which is moved outside the said cylinder (16).

3. Piston (14) according to claim 1, characterized in that the said cylinder (16) is made from a nonmagnetic material.

4. Piston (14) according to claim 1, characterized in that it is made from a material sensitive to a magnetic field.

5. Piston (14) according to claim 4, characterized in that it is made from a metallic material.

6. Piston (14) according to claim 1, characterized in that it is used in a reciprocating machine.

7. Piston (14) according to claim 6, characterized in that the said reciprocating machine is a reciprocating compressor (12).

8. Piston (14) according to claim 1 or 7, characterized in that the said external magnetic element (20) is moved by a reciprocating motor.

9. Piston (14) according to claim 8, characterized in that the said reciprocating motor is of the pneumatic type.

10. Piston (14) according to claim 8, characterized in that it is not provided with a central operating rod.

11. Piston (14) according to claim 1 or 7, characterized in that the said cylinder (16) has no seal in contact with the exterior.

12. Piston (14) according to claim 7, characterized in that the said reciprocating compressor (12) is double-acting.
